(19) United States
(12) Patent Application Publication
(10) Pub. No.: US 2025/0025954 A1
(43) Pub. Date: Jan. 23, 2025

(54) FEMALE THREAD REPAIRING TOOL

(71) Applicant: Yulia USPENKAYA, Winsen (DE)

(72) Inventors: Boris Semenovich LITVAK, Moscow (RU); Philipp Sebastian SILBERKUHL, Moscow (RU)

(21) Appl. No.: 18/711,226

(22) PCT Filed: Nov. 22, 2021
(86) PCT No.: PCT/RU2021/000518

§ 371 Date: May 17, 2024

(51) Int. Cl. B23G 7/02; B21H 3/08; B23P 6/00

(52) U.S. Cl. CPC B23G 7/02; B21H 3/08; B23P 6/00

(57) ABSTRACT

The pending invention relates to means for repairing female threads. The claimed thread repairing tool (1) for repairing a female thread (2) being damaged comprises the case (3), the first beam (4), the second beam (5), the forming roller (6) rotatably and movably installed on the first beam (4), the pitch profile means (7) installed on the second beam (5), and the adjusting means for providing reciprocal moving to and apart from each other and fixing the first beam (4) and the second beam (5). The invention provides a universal robust tool for repairing female threads allowing adjustment thereof to a diameter of the thread being repaired while applying substantially rolling of the material the thread is made of but not cutting thereof.

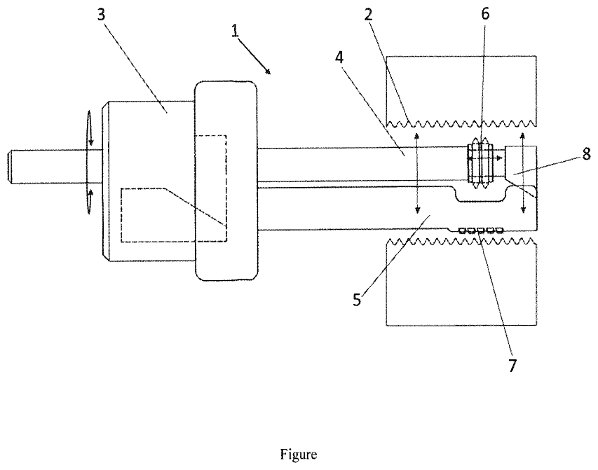

The pending invention relates to means for repairing female threads.

Repairing especially small female threads, or internal threads, is known to be a more complicate task than repairing male threads. Not always a workpiece with a damaged, i.e. having imperfections, female thread can be replaced with a new one due to long lead times or high total costs. On the other hand, the already known repairing tools for female threads are quite complicate in use and usually applicable for the female thread of one given diameter.

Another concern of the known repairing tools is that these do not carry out repairing a damaged thread as such. Rather, the damaged thread is cut by said tools to make the threads workable again. Obviously, cutting the damaged thread results in removing a portion of the material the thread is made of, thus causing weakening the repaired thread, especially that one of a small pitch.

EP3337642A1 discloses the simple thread repairing tool useful for female threads and comprising the single roller installed on the shaft. When repairing, the tilting moment acting on the tool is too great, and the damaged profile of the thread is not formed properly. This is of especial concern for metal threads, a material most threads are made of. It has been revealed that at least two such rollers are required for proper forming the broken thread by said known tool. Otherwise, the roller is tilted by the pitch angle of the thread thus causing cutting the thread instead of rolling thereof.

The closest prior art for the present invention is the tool for rolling internal threads according to U.S. Pat. No. 3,069,939A eliminating some disadvantages of the above mentioned simple thread repairing tool. The closest prior art comprises the holder and at least two pins mounted on said holder. The thread forming roll is rotatably mounted on each pin. The axes of the rolls are spaced from the axis of the holder and are parallel thereto in one plane and at an angle thereto in another plane. The pin can be moved longitudinally for adjusting the longitudinal position of this pin on the holder, to adjust the longitudinal position of the rolls with respect to each other. Since the pins are not movable to and/or apart from each other (that is in the direction substantially perpendicular to the pins) the known tool is made for one specific diameter, i.e. not adjustable. Repairs are difficult to impossible due to that. Besides, initial engaging of the rolls with the broken thread is somewhat difficult because of the same reason, so a specific buckled form of the thread profile is advisable to diminish, though not fully avoid, cutting of the thread being repaired. Making one pin movable for adjusting the longitudinal position of this pin on the holder does not really help precisely initial aligning the roll with thread being repaired.

The objective of the present invention is providing a universal thread repairing tool for repairing female threads that eliminates the disadvantages of the known tools, namely allows fine adjustment to a diameter of the thread being repaired while applying substantially rolling to the thread rather than cutting thereof.

The technical result of the invention is repairing a female thread, even a heavily damaged female thread, upon rolling a material of the thread and avoiding cutting thereof, while allowing repairing of female threads of different diameters.

For achieving said objective and technical result, a thread repairing tool for repairing a female thread comprises a case, a first beam with a forming roller rotatably and movably installed thereon and having a first beam axis, a second beam with a pitch profile means installed thereon and having a second beam axis, and an adjusting means for moving to and apart from each other and fixing the first beam and the second beam.

Making the first beam and the second beam movable forth from and back to each other and fixing thereof in a given position by the adjustable means allows repairing female threads of different diameters while keeping the reciprocal position of the first beam and the second beam substantially constant and parallel to each other. As a result, the thread being repaired is rolled rather than cut.

Due to tolerances of the female thread the first beam and the second beam, at a fixed position thereof, may appear to be not exactly parallel to each other. However, an angle between the first beam axis and the second beam axis shall not exceed a pitch angle of said female thread. Thus, a small angle between the first beam axis and the second beam axis is allowed though not desirable, and said angle is limited by said pitch angle of the female thread being repaired.

To make the process of repairing easier and safe, especially at the stage of engaging the tool with the thread, the forming roller shall be made movable along with first beam axis at a distance of at least a half pitch of the female thread.

Altogether it allows to make the tool adjustable to the diameter of the thread making engaging the tool with the thread easy and safe, using the repairing roller of a simple shape, and completely or almost completely avoiding cutting of the thread when repairing the latter.

The pitch profile means (5) may be is a coiled profile means being fixed to the second beam, or a roller means, in particular, made rotatable around and movable along with the second beam axis. All these options provide for better and correct engaging the forming roller with the female thread being repaired.

It is also preferable if the adjusting means comprises a displaceable cone, to make the claimed tool both simple in use and robust, allowing to keep the angle between the first beam axis and the second beam axis at the required angle at any reciprocal position of the first beam and the second beam.

The invention is further described in more detail with reference to the enclosed FIGURE showing possible variants of implementation of the claimed tool, which however do not limit the invention to these only variants.

The claimed thread repairing tool (1) for repairing a female thread (2) being damaged comprises a case (3), a first beam (4) having a first beam axis (not shown in the FIGURE), a second beam (5) having a second beam axis (not shown in the FIGURE), a forming roller (6) rotatably and movably installed on the first beam (4), a pitch profile means (7) installed on the second beam (5), and an adjusting means for reciprocal moving and fixing the first beam (4) and the second beam (5).

For repairing the female thread (2), the first beam (4) and the second beam (5) are moved in the direction to each other by means of the adjusting means so that it is possible to easily insert the thread repairing tool (1) in the opening with said female thread (2).

Then, if necessary, a distance between the first beam (4) and the second beam (5) is increased by means of the adjusting means, to bring in tight or required contact the forming roller (6) and, oppositely, the pitch profile means (7) with the respective portions of the female thread (2).

Once the required position of the first beam (4) and the second beam (5) is set, the thread repairing tool (1) is rotated around an axis thereof, to repair the female thread (2) by rolling back the material that was misplaced due to damaging the female thread (2). While rotating, said distance between the first beam (4) and the second beam (5) can be further adjusted by the adjusting means, to effectively though precisely roll a material which the female thread (2) is made of.

Once the female thread (2) is repaired, the thread repairing tool (1) is extracted from the opening with the female thread (2). If necessary, prior to that the distance between the first beam (4) and the second beam (5) can be decreased by the adjusting means.

For easy, precise and safe positioning of the forming roller (3) when engaging with the respective portion of the female thread (2) to be repaired, the forming roller (3) is made movable along with first beam axis, as shown in the FIGURE by the respective arrow. A distance of said movement of the forming roller (3) along with first beam axis is preferred to be at least a half pitch of the female thread (2).

To avoid cutting the material of the female thread (2), the first beam (4) and the second beam(S) shall be moved and fixed at any working position thereof substantially parallel to each other. Here the term of “substantially parallel” means that an angle between the first beam axis and the second beam axis shall be small enough to fully or mostly avoid cutting the material. It has been found that the angle of approximately not exceeding the pitch angle of the female thread (2) being repaired is most preferable.

The forming roller (6) may have a coiled profile or a coil-less profile. The geometry of the forming roller (6) matches the profile of the female thread (2) that is to be repaired. The profile of the forming roller (6) can be applied in the form of a spiral on a surface of the forming roller (6) or in the form of parallel rings in amount of one to five rings, a small number of the rings being preferred.

The pitch profile means (7) has a profile according to the pitch of the female thread (2) to be repaired. It can vary in a height and a width to reduce a surface touching the female thread (2) during repair. Said profile may be coiled or just parallel.

The pitch profile means (7) may be made fixed or movable. For instance, the pitch profile means (7) may be made in the form of a coiled profile means as actually shown in the FIGURE. Alternatively, the pitch profile means (7) may be made in the form of a roller means, i.e. be a roller. In the latter case, it is preferable if said roller means is made rotatable around and, additionally but not necessarily, movable along with the second beam axis.

The adjusting means can be of any known kind suitable for safe fixing and substantially parallel reciprocal movement of the first beam (4) and the second beam (5). It has been found that one of the possible variants is the adjusting means comprising a displaceable cone (8), as shown in the FIGURE. In this very case, moving the first beam (4) forth and back along with the first beam axis, i.e. from and to the case (3), causes a free end of the first beam (4) where the displaced cone (8) is mounted or formed on to move to or apart from the second beam (5), while keeping the first beam (4) and the second beam (5) substantially parallel to each other.

Thus, the invention provides a universal robust tool for repairing female threads allowing adjustment to a diameter of the thread being repaired while applying substantially rolling to the thread but not cutting thereof.

1. A thread repairing tool for repairing a female thread, comprising:
a case,
a first beam connected to the case having a first beam axis,
a second beam connected to the case having a second beam axis,
a forming roller installed on the first beam, wherein said forming roller is made rotatable around the first beam axis,
a pitch profile means installed on the second beam, and
an adjusting means for moving the first beam and the second beam to and apart from each other, and for fixing the first beam and the second beam at a fixed position, wherein an angle between the first beam axis and the second beam axis does not exceed a pitch angle of the female thread, and wherein the forming roller is movable along with the first beam axis at a distance of at least a half pitch of the female thread.

2. The thread repairing tool of claim 1, wherein the pitch profile means is a coiled profile means.

3. The thread repairing tool of claim 2, wherein the pitch profile means is a roller means.

4. The thread repairing tool of claim 3, wherein the roller means is rotatable around and movable along with the second beam axis.

5. The thread repairing tool of claim 1, wherein the adjusting means comprises a displaceable cone.
